(19) United States
(12) Patent Application Publication
(10) Pub. No.: US 2020/0175483 A1
(43) Pub. Date: Jun. 4, 2020

(54) DEPLOYING AND LOCATING MOBILE BANKING UNITS

(71) Applicant: Capital One Services, LLC, McLean, VA (US)

(72) Inventors: Jeremy J. Phillips, McLean, VA (US); Gregory Mazurek, New York, NY (US)

(73) Assignee: Capital One Services, LLC, McLean, VA (US)

(21) Appl. No.: 16/205,627

(22) Filed: Nov. 30, 2018

(51) Int. Cl. G06Q 20/10; G06Q 40/02

(52) U.S. Cl. CPC G06Q 20/1085; G06Q 40/02

(57) ABSTRACT

In one aspect, the present disclosure relates to a method for improving the reliability of a bank computer network, the method including: monitoring resources for a plurality of banking locations; detecting a first one of the plurality of banking locations is deficient in one or more resources, determining a first target location for a first mobile banking unit (MBU) based on the location of the first one of the plurality of banking locations; deploying the first MBU to the first target location; and sending a notification to a plurality of user devices, the notification comprising a location of the first MBU and information about services provided by the first MBU.

### BACKGROUND

A bank may provide services to its customers at various physical locations such as branch locations and automated teller machines (ATMs). To provide banking services, a physical bank location may require various resources such as power, network connectivity, and tangible currency (“cash”). In addition to stationary bank locations, banks may deploy vehicle-based ATMs and other types of mobile banking units (MBUs) to strategic locations to increase availability of baking services.

Banks may provide banking services online via a website and/or mobile app. Some bank apps include an “ATM locator” feature that displays the location of its ATMs, MBUs, and other service locations on an interactive mapping interface. To show an accurate and complete map of its locations—include mobile locations—a mobile app may pull real-time data from a server using WiFi, cellular networking, or other type of wireless networking.

### SUMMARY

According to one aspect of the present disclosure, a method for improved reliability of a bank computer network includes: monitoring resources for a plurality of banking locations; detecting a first one of the plurality of banking locations is deficient in one or more resources; determining a first target location for a first mobile banking unit (MBU) based on the location of the first one of the plurality of banking locations; deploying the first MBU to the first target location; and sending a notification to a plurality of user devices, the notification including a location of the first MBU and information about services provided by the first MBU.

In some embodiments, monitoring resources for the plurality of banking locations includes at least one of: monitoring cash available at one or more of the banking locations; monitoring power available at one or more of the banking locations; and monitoring network connectivity for one or more of the banking locations. In some embodiments, monitoring resources for a plurality of banking locations includes using a weather forecast to estimate resources for the plurality of banking locations at a future time. In some embodiments, determining the target location includes estimating customer demand for banking services within a geographic area. In some embodiments, the mobile ATM includes an autonomous vehicle. In some embodiments, the mobile ATM includes a solar-powered battery.

According to another aspect of the present disclosure, a method includes: determining a target location for a mobile automatic teller machine (ATM); deploying the mobile ATM to the target location; and transmitting the target location from the mobile ATM to a plurality of user devices using a peer-to-peer communications, each of the plurality of user devices configured to present a user interface (UI) showing the target location of the mobile ATM on a map.

In some embodiments, determining the target location includes: monitoring resources for a plurality of banking locations; detecting a first one of the plurality of banking locations is deficient in one or more resources; and determining the target location based on a location of the first one of the plurality of banking locations. In some embodiments, the one or more resources include at least one of: cash; power; and network connectivity. In some embodiments, determining the target location includes: estimating customer demand for banking services within a geographic area. In some embodiments, the peer-to-peer communications includes Bluetooth communications. In some embodiments, the peer-to-peer communications includes wireless mesh network communications. In some embodiments, the method includes: determining a first location of the mobile ATM; transmitting the first location of the mobile ATM to the plurality of user devices; determining a second location of the mobile ATM; transmitting the second location of the mobile ATM to the plurality of user devices, wherein each of the plurality user devices is configured to present the UI showing a tracked location of the mobile ATM, the tracked location based on at least the first location and the second location.

According to another aspect of the present disclosure, a system includes a processor, a resource monitoring module, a mobile banking unit (MBU) deployment module, and a customer notification module. The resource monitoring module can be configured for execution on the processor to: monitor resources for a plurality of banking locations, and detect a first one of the plurality of banking locations is deficient in one or more resources. The MBU deployment module can be configured for execution on the processor to: determine a first target location for a first MBU based on the location of the first one of the plurality of banking locations, and deploy the first MBU to the first target location. The customer notification module can be configured for execution on the processor to: send a notification to a plurality of user devices, the notification including a location of the first MBU and information about services provided by the first MBU.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is a diagram of a system for deploying and locating banking services, according to some embodiments of the present disclosure.

FIG. 2 is a diagram of a peer-to-peer communication network, according to some embodiments of the present disclosure.

FIGS. 3-6 are flow diagrams showing processing that may occur within the system of FIG. 1, according to some embodiments of the present disclosure.

FIG. 7 is a block diagram of a server device, according to some embodiments of the present disclosure.

FIG. 8 is a block diagram of a user device, according to some embodiments of the present disclosure.

The drawings are not necessarily to scale, or inclusive of all elements of a system, emphasis instead generally being placed upon illustrating the concepts, structures, and techniques sought to be protected herein.

### DETAILED DESCRIPTION

Embodiments of the present disclosure relate to deploying mobile banking units (MBUs) to strategic locations. MBUs can include, for example, automated teller machines (ATMs) located within or upon a vehicle (“vehicle-based ATMs”). MBUs can be deployed based on customer demand for cash or other banking services. Demand for banking services can increase during special events or in emergency situations. For example, an MBU can be deployed to area impacted by a hurricane or other natural disaster where there would be a high demand for cash. As another example, MBUs can be deployed to a location near a concert, festival, or other event where an influx of people is expected. MBUs can be in wireless communication with a bank computer network. In some embodiments, a system may monitor resource availability (e.g., power, network connectivity, or cash reserves) at one or more bank locations and automatically deploy MBUs nearby if a resource deficiency is detected. As such, embodiments of the present disclosure can improve the reliability and coverage of bank computer networks. In some embodiments, a system can use data from a weather service, utility provide (e.g., via an API), or other third party service to determine when and where a MBU should be deployed. For example, if a utility company reports a power outage in a particular area, embodiments of the present disclosure can automatically deploy a MBU to the affected area. In some embodiments, MBUs may be deployed autonomously, for example using self-driving vehicles.

Embodiments of the present disclosure relate to multimodal communications for locating ATMs, MBUs, and other bank locations. An app running on a user's device can include a mapping interface for displaying bank locations and available banking services. In a first mode of communication—referred to herein as “server mode”—a user device can receive real-time bank location data from a server device via a cellular, Wi-Fi, or other type of wireless network connection. If connectivity to the server becomes unavailable (e.g., as a result of a high demand on a cellular network), then the user device may automatically switch to a second mode of communication referred to herein as “peer mode.” A skilled artisan will understand that smartphones and other mobile devices may include circuitry and antennas capable of communicating directly with nearby devices (i.e., without relying on centralized network infrastructure such as cellular towers). For example, mobile devices may be capable of communicating with nearby devices using beacon- or Bluetooth-based communications. In peer mode, a user device can detect and receive wireless signals transmitted by nearby MBUs and other bank locations. The signals may include the bank location's geographic coordinates along with information about banking services available at that location. The user device can decode the signals and display the bank information on a mapping interface. In some embodiments, user devices can re-transmit the signals to other nearby devices, creating an ad-hoc mesh network. In some embodiments, bank locations can transmit notifications in peer mode. For example, a bank can relay wireless signal broadcast by rescue authorities to the bank's customers.

Embodiments of the present disclosure relate to predicting when a user may need banking services and presenting recommendations to the user based on their location. In some embodiments, a system predicts when a user is low on cash based on analyzing transactions performed by that user. The system can send a notification to the user's device along with the location of the nearest bank location for withdrawing cash. In some embodiments, the system can recommend that a user withdraw cash in response to detecting that a credit card network associated with the user is unavailable (such as a credit card in the user's mobile wallet). In some embodiments, the bank may collect information from point-of-sales (POS) systems to determine when a user likely performed a cash transaction. For example, a beacon-based POS system may sense a credit card nearby while a cash transaction is performed. Using this information, the bank can estimate how much cash a user associated with that credit card spent since their last ATM withdrawal and, thus, predict when the user is low on cash and should visit an ATM. In some embodiments, a system can use data from a weather service, utility company, or other third party to determine when a user should visit a bank location and what type of transaction they should perform. For example, if a hurricane is forecast to affect an area near the user's home or current location, the system may notify the user to withdraw cash and to order a refill of checks. A notification sent to the user's device can direct the user to a nearby bank location providing the recommended banking services.

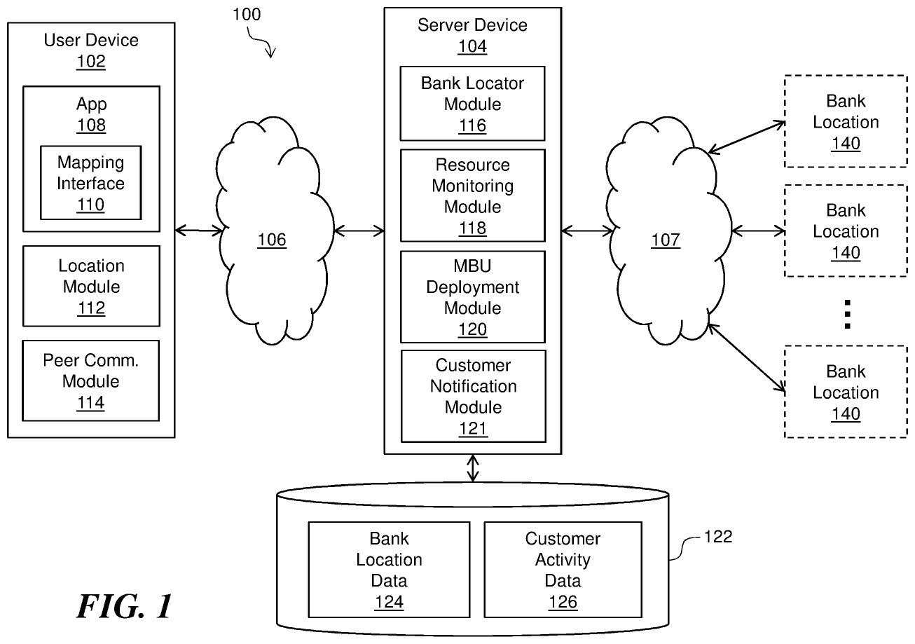

Referring to FIG. 1, a system 100 can be used for deploying and locating banking services, according to some embodiments of the present disclosure. The illustrative system 100 includes a one or more user devices 102 operatively coupled to a server device 104 via a network 106. Network 106 can correspond to one or more wireless or wired computer networks. Server device 104 may be operatively coupled to one or more bank locations 140 via network 107, which may be the same as or similar to network 106. Bank locations 150 can include stationary bank locations such as branch locations and stationary ATMs, along with vehicle-based ATMs and other types of MBUs. In some embodiments, network 107 may correspond to a bank computer network via which bank locations 140 can be interconnected. In some embodiments, server device 104 may form a part of the bank computer network.

The service device 104 can include a bank locator module 116, a resource monitoring module 116, a MBU deployment module 120, and a customer notification module 121. The server device 104 can further include, or otherwise be coupled to a database 122. The illustrative database 122 can store, for example, bank location data 124 and customer activity data 126. Bank location data 124 can include information about bank locations 140, such as a street address or geographic coordinates (e.g., latitude and longitude values) for each bank location 140. In some embodiments, bank location data 124 may store information about the types of banking services available at each bank location 140. For example, bank location data 124 may indicate which bank locations 140 allow cash withdrawals, which locations allow deposits, which locations have tellers, etc. The available service information may be updated dynamically based on available resources at a given bank location, as discussed below. Customer activity data 126 can include historic information about transactions made by bank customers. For example, customer activity data 126 may include information about cash withdrawals and POS transactions performed by a given customer. In some embodiments, customer activity data 126 can include aggregate or statistical activity data for one or more customers, such as the average number of cash withdrawals per week/month and the average withdrawal amount. Customer activity data 126 can be received from, or based on information received from, a bank computer network.

Bank locator module 116 may be configured to provide information about bank locations 140 to user devices 102. For example, bank locator module 116 can access bank location data 124 to determine the geographic coordinates and available services for one or more bank locations 140, and provide this information to user devices 102. In some embodiments, bank locator module 116 may include an application programming interface (API) configured to receive requests from, and send responses to, an app 108 running on the user device 102. App 108 can use data from bank locator module 160 to display real-time status information about bank locations 140, such as whether a nearby ATM has cash available for withdrawal.

Resource monitoring module 118 may be configured to monitor resources available to each of the bank locations 140. A bank location may depend upon various resources such as power, network connectivity, staffing, and reserves or delivery of cash and other financial supplies. At certain times, those resources can become unavailable due to, for example, extreme weather conditions, planned downtime, or high customer demand. Resource monitoring module 118 can monitor each bank location 140 to determine when critical resources are cut off or otherwise become unavailable. In some embodiments, module 118 can receive data from sensors located at one or more of the bank locations 140. For example, a sensor may report, via an API, if a bank location has full power, is operating on reserve power, or if it has no power. As another example, module 118 can query a sensor's API to determine if a bank location has wired (e.g., Ethernet) network connectivity, wireless connectivity, modem-based connectivity, or no network connectivity. As another example, weight-based sensors can be used to monitor the level of cash, checks, or other stock at the bank location. In some embodiments, module 118 can determine whether a bank location is fully staffed or understaffed by: (1) querying a scheduling application to determine the number of employees are scheduled to be working at a given time, (2) determining the number of employees currently logged into to workstations at the bank location, and (3) comparing the two numbers to determine a staffing level at the bank location.

In response, module 118 can update bank location data 124 and/or cause a notification to be sent to user devices 102 indicating that the bank location is no longer operational or that certain banking services are no longer available at that location. For example, if module 118 detects that a bank location 140 has lost power (e.g., as a result of a power grid failure), it can update bank location data 124 to indicate that bank location is no longer operational. As another example, if module 118 detects that a bank location 140 has low cash reserves, it can update bank location data 124 to indicate that cash withdrawals are not available at that location. The updated service information for the bank location can be transmitted to user devices 102, providing real-time status information to customers.

MBU deployment module 120 can determine where, when, and how MBUs are deployed. In some embodiments, MBU deployment module 120 can deploy an MBU nearby an existing bank location 140 in response to determining that the bank location has limited or no access to power, network connectivity, cash reserves, or other resource. Deployment module 120 can query bank location data 124 to determine when a bank location has lost a resource and is no longer able to provide particular banking services. In some embodiments, deployment module 120 can make a deployment decision based on information received from one or more external data sources, such as a weather service or event notification/planning service. In some embodiments, MBU deployment module 120 can decide to deploy an MBU based on customer activity data 126. For example, module 120 can analyze history customer activity data to predict a high demand for banking services, or monitor real-time customer activity to respond to an actual increase in demand. In some embodiments, MBU deployment module 120 can cause an MBU to be deployed by, for example, sending commands to an anonymous vehicle on which the MBU is transported. When a MBU is deployed, module 120 can notify customers and/or bank employees of the new bank location. For example, module 120 can update bank location data 124 with the target location for a newly deployed MBU, which can cause the new location to appear on a mapping interface of customer's user devices 102. In some embodiments, customers can track the movement of MBUs in real-time on their devices 102.

Customer notification module 121 can generate and transmit notifications to user devices 102. Notifications can include, for example, push notifications, in-app notifications, text messages, or email messages. In some embodiments, customer notification module 121 can notify a user when a MBU has been deployed to location proximate to the user's current location, home address, work address, or another location associated with the user. In some embodiments, module 121 can notify customers when a natural disaster is forecast to affect an area near the user's location. In some embodiments, customer notification module 121 can receive alerts from rescue authorities and relay these alerts to user devices 102. In some embodiments, module 121 can send notifications recommending that users withdraw cash or performs another transaction at a nearby bank location. Such recommendations can be based on historic information about that customer's spending patterns or an estimate or how much cash the customer has in their possession. In some embodiments, customer notification module 121 can analyze customer activity data 126 to determine which notifications should be sent and when. For example, module 121 can analyze ATM transactions to determine how much cash a customer withdrew and then analyze POS information to determine how much of that cash the customer likely spent. If module 121 determines that a user is low on cash, it may send a notification to the user's user device 102 recommending the user withdraw cash.

A user device 102 can include one or more user applications (or “apps”), a location module 112, and an peer communication module 114. Location module 112 can include, for example, a Global Positioning System (GPS) receiver. Peer communication module 114 can include, for example, radio frequency (RF) transceiver circuitry. A skilled artisan will understand that mobile phones and other user devices may include RF antennas and radio circuitry that can be used for transmitting wireless signals to, and receiving wireless signals from, nearby devices according to various modulation schemes. In some embodiments, user device 102 can include a Bluetooth receiver, which may be part of, or separate from, peer communications module 114. In some embodiments, user device 102 can include a Bluetooth Low-Energy (BLE) receiver. In some embodiments, user device 102 can include hardware and/or software for establishing the device as a node of a wireless mesh network.

An illustrative app 108 can include a mapping interface 110 to display available bank locations and services to customers. App 108 can determine the customers current location using location module 112 and, based on this, display information nearby bank locations and services. In some embodiments, app 108 can receive real-time bank location data from server device 104 (e.g., from bank locator module 116). For example, app 108 can track the location of MBUs deployed by server device 104. In some embodiments, app 108 can display notifications to the customer. Notifications can be received from server device 104 (e.g., from customer notification module 121) or generated within the app itself.

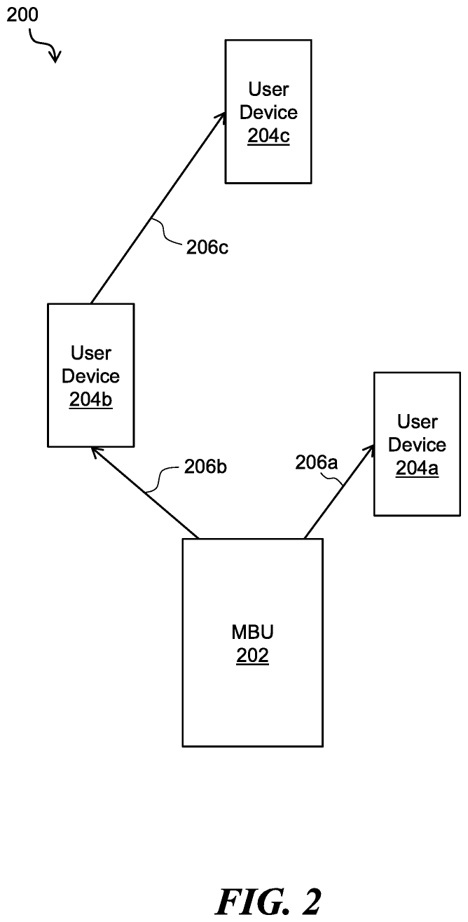

In some embodiments, app 108 may be configured to use multimodal communications for locating MBUs and other bank locations. In “server mode,” app 108 can receive real-time bank location data generated by server device 104 via a cellular, Wi-Fi, or other type of wireless network connection. If connectivity to the server becomes unavailable (e.g., as a result of a power outage or high demand on the server), then app 108 may switch to “peer mode.” In some embodiments, app 108 may try to connect to the server a predetermined number of times before automatically switching to peer mode. In peer mode, app 108 can use peer communications module 114 to communicate with nearby bank locations and other user devices. In some embodiments, multiple user devices 102 can establish a mesh network for relaying bank location data as illustrated in FIG. 2.

In some embodiments, app 108 may be part of a banking app that allows bank customers to review their account balance, deposit checks, and/or utilize other online banking services.

FIG. 2 illustrates how MBUs and user devices can communicate using peer mode. In the example shown, an peer-to-peer communication network 200 can include an MBU 202 and a plurality of user devices user device 204a, 204b, 204c (204 generally). The MBU 202 may be deployed autonomously to a target location, according to some embodiments. For example, if the system 100 of FIG. 1 determines that there is an increased number of user devices 204 in a particular area (e.g., due to a concert or other event), it may deploy MBU 202 to a location nearby the user devices 204. The MBU 202 may include circuitry to transmit wireless signals. The transmitted signals may include information such as the location of the MBU 202 and the types of banking services offered by the MBU 202.

Initially, in server mode, user devices 204 may receive bank information from a server device (e.g., server device 104 in FIG. 1) via a cellular network. For example, devices 204 can receive location information for nearby bank locations (including MBU 202) along with the types of services offered by each location. Over time, cellular service may degrade has the number of user devices 204 increases (e.g., during a concert or other event) and/or as the per-user data usage increases (e.g., during a natural disaster). A concert or other event may cause there to be a particularly high concentration of users within a given area, which places a strain on cellular bandwidth.

User devices 204 can detect a degradation in cellular service and, in response, automatically switch to peer mode, wherein the user devices 204 listen and receive wireless signals transmitted from nearby devices. For example, user devices 204a and 204b may receive Rsignals transmitted by MBU 202 as indicated by arrows 206a and 206b in FIG. 2. In some embodiments, user devices can transmit or relay information to other user devices, forming an ad-hoc wireless mesh network. For example, user device 204b may transmit bank information to user device 204c as indicated by arrow 206c. In this way, user devices that are outside of the range of the MBU's transmitted signal can receive the same information indirectly. It will be appreciated that the techniques described herein can improve the reliability and coverage of bank computer networks.

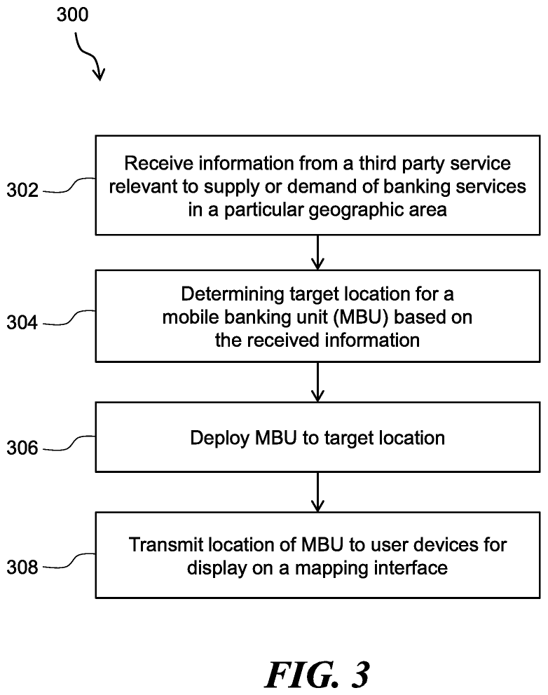

Referring to FIG. 3, a method 300 can be used to automatically deploy MBUs to locations where the supply of banking services may be insufficiently to meet demand. At block 302, information may be received from a third party service. The information may be generally relevant to the supply of, or demand for, banking services in a particular area. For example, information may be retrieved from a weather service, utility company, concert listing website and other events listing service, social network, etc.

At block 304, a target location for a MBU may be determined based on the received information. For example, if the received information indicates that a hurricane will strike a particular city, then a target location within that city may be determined for the MBU. In some embodiments, factors that may be used to determine the target location include: density of bank customers in a geographic area, overall population density in a geographic area, proximity to existing bank locations, availability of power and network connectivity in a geographical area, risk of flooding in a geographic area. In some embodiments, the target location may be determined by estimating customer demand for banking services within a geographic area, for example using historic customer activity data.

At block 306, the MBU may be deployed to the target location. In some embodiments, the MBU be transported using an autonomous vehicle. In some embodiments, the MBU may be solar-powered. At block 308, the location of the MBU may be transmitted to one or more user devices. The user devices may be configured to run an app with a mapping interface to display the location of the MBU and other banking locations. In some embodiments, user devices can receive the location of the MBU in real-time or near-real-time from a server. In some embodiments, the app may be configured to present a notification to the user when a new MBU has been deployed nearby the user device.

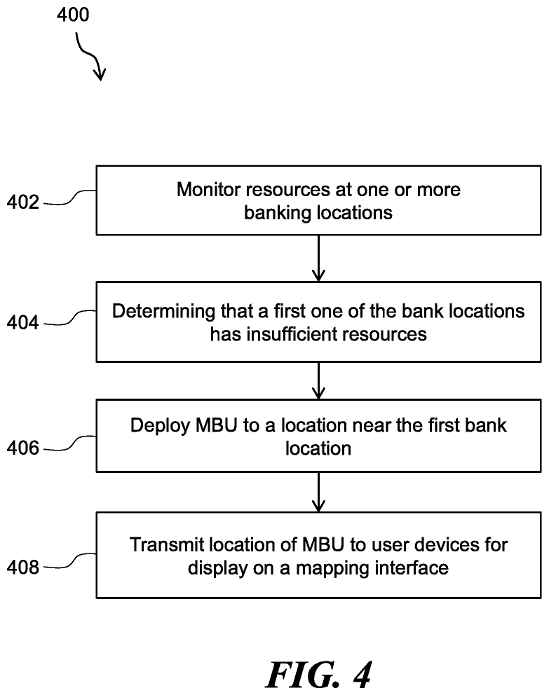

Referring to FIG. 4, a method 400 can be used to automatically deploy MBUs to locations in response to detecting a banking location has insufficient resources. At block 402, resources at one or more banking locations may be monitored for example, by resource monitoring module 118 of FIG. 1. Monitored resources can include available cash, power, and/or network connectivity for the bank locations. At block 404, it is determined that a first one of the bank locations has insufficient resources. For example, it can be determined that the bank location is low on cash reserves, or that it has lost network connectivity. In some embodiments, blocks 402 and 404 may include using techniques described above in conjunction with monitoring module 118 of FIG. 1.

At block 406, an MBU can be deployed to a location near the first bank location and, at block 408, the location of the MBU can be transmitted to user devices. As discussed above in conjunction with FIG. 1, user devices can include a mapping interface to display the location of the MBU and other bank locations proximate to the user device. In some embodiments, user devices can receive the location of the MBU in real-time or near-real-time from a server. In some embodiments, the app may be configured to present a notification to the user when a new MBU has been deployed nearby the user device.

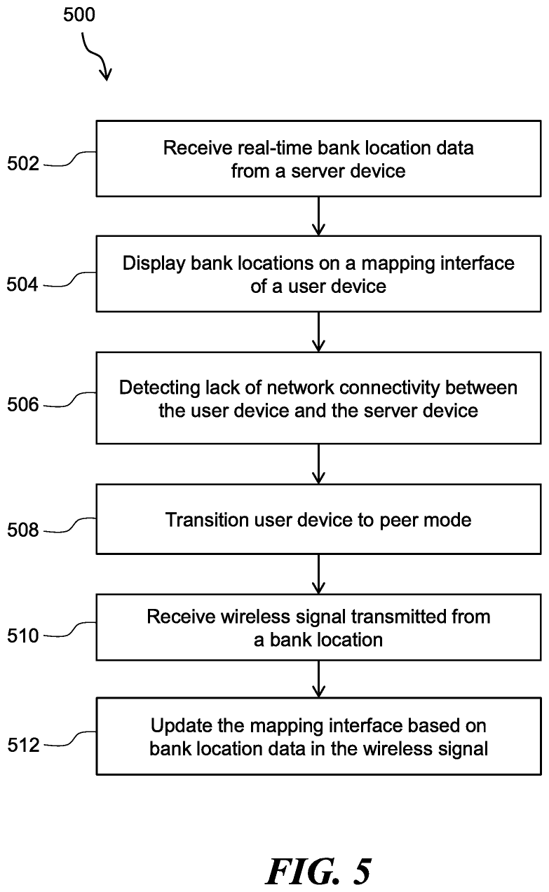

Referring to FIG. 5, a method 500 can be used to improve the reliability of a bank computer network using multiple modes of communication. At block 502, real-time bank location data may be received from a server device. Bank location data can include geographic coordinates for one or more bank locations proximate to the user device, along with the types of banking services available at each of those locations. At block 504, the bank location data can be displayed on a mapping interface of a user device. In some embodiments, the mapping interface can be part of a banking app.

At block 506, it can be detected that there is a lack of network connectivity between the user device and the server device. For example, the user device may detect that it has lost cellular service, or that the latency between the user and server devices above a predetermined threshold latency. At block 508, the user device may transition from server mode into peer mode. In some embodiments, blocks 506 and 508 may include using techniques described above in conjunction with app 108 of FIG. 1 for switching to peer mode.

At block 510, the user device may receive a wireless signal transmitted from a nearby bank location, such as a MBU or branch location. The received signal may encode the bank location's coordinates and/or a list of bank services available at the bank location. At block 512, the mapping interface may be updated based on the information in the received signal.

A skilled artisan will understand how to combine method 500 of FIG. 5 with method 300 of FIG. 3 and/or method 400 of FIG. 4 to further improve bank network communications. For example, the multimodal communications of FIG. 5 can be employed at block 308 of FIG. 3 to transmit the location of the MBU to user devices lack connectivity to the server.

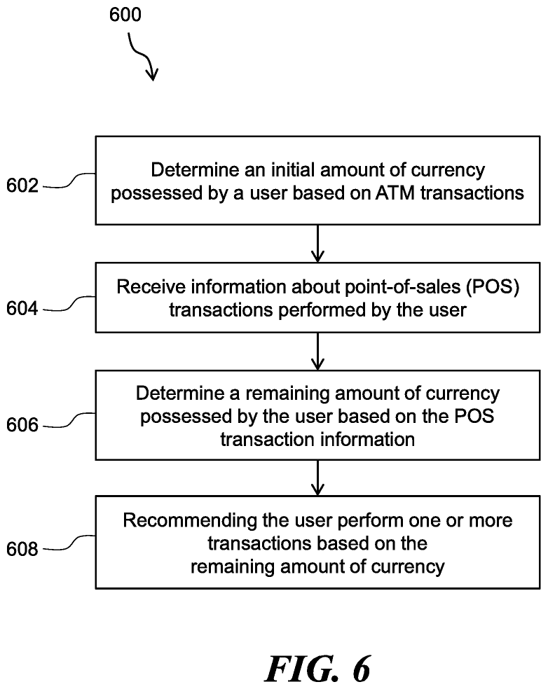

Referring to FIG. 6, a method 600 can be used to predict when a user may need banking services and to present recommendations to the user based on their location. At block 602, an initial amount of cash within the user's possession is determined/estimated. This can be based, for example, on the amount of cash the user most recently withdrew from their bank account. At block 604, information is received about point-of-sales (POS) transactions performed by the user. The POS transaction information may be received from merchant POS systems and can include cash transactions and credit/debit transactions. For cash transactions, the POS system can identify particular users based on a unique identifier transmitted by credit/debit cards within the user's wallet (e.g., using near-field communication (NFC) or beacon technology).

At block 606, the POS transaction information may be used to determine how much cash the user has remaining. For example, the total amount of cash transactions performed by the user may be subtracted from their initial cash amount (from block 602) to estimate much money the user has remaining in their possession. At block 608, a notification may be sent to the user recommending that the user perform one or more transactions based on their remaining cash. The decision to send such a notification may be based not only on the user's remaining cash, but also on historic activity data for the user. For example, if the user historically spends X dollars per day and is estimated to have less than X dollars in their possession, a notification may be sent the customer's user device along with the location of the nearest bank location for withdrawing cash. In some embodiments, information about nearby events or weather emergencies can be used to determine when to send a recommendation to the user.

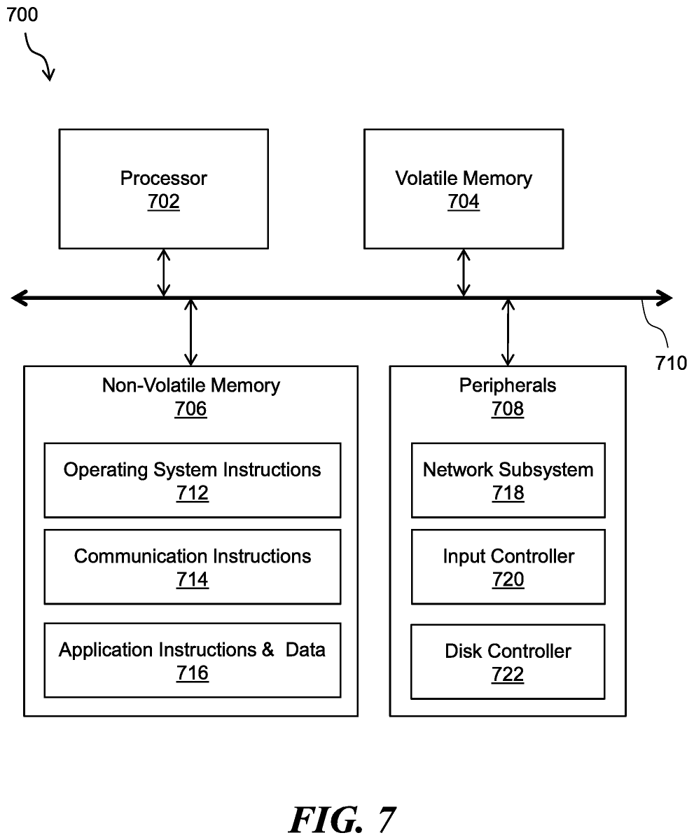

FIG. 7 shows an illustrative server device 700 that may implement various features and processes as described herein. The server device 700 may be implemented on any electronic device that runs software applications derived from compiled instructions, including without limitation personal computers, servers, smart phones, media players, electronic tablets, game consoles, email devices, etc. In some implementations, the server device 700 may include one or more processors 702, volatile memory 704, non-volatile memory 706, and one or more peripherals 708. These components may be interconnected by one or more computer buses 710.

Processor(s) 702 may use any known processor technology, including but not limited to graphics processors and multi-core processors. Suitable processors for the execution of a program of instructions may include, by way of example, both general and special purpose microprocessors, and the sole processor or one of multiple processors or cores, of any kind of computer. Bus 710 may be any known internal or external bus technology, including but not limited to ISA, EISA, PCI, PCI Express, NuBus, USB, Serial ATA or FireWire. Volatile memory 704 may include, for example, SDRAM. Processor 702 may receive instructions and data from a read-only memory or a random access memory or both. The essential elements of a computer may include a processor for executing instructions and one or more memories for storing instructions and data.

Non-volatile memory 706 may include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 706 may store various computer instructions including operating system instructions 712, communication instructions 714, application instructions and data 716. Operating system instructions 712 may include instructions for implementing an operating system (e.g., Mac OS®, Windows®, or Linux). The operating system may be multi-user, multiprocessing, multitasking, multithreading, real-time, and the like. Communication instructions 714 may include network communications instructions, for example, software for implementing communication protocols, such as TCP/IP, HTTP, Ethernet, telephony, etc. Application instructions and data 716 can include instructions and data to perform some of the processing described above in conjunction with FIGS. 3-6.

Peripherals 708 may be included within the server device 700 or operatively coupled to communicate with the sever device 700. Peripherals 708 may include, for example, network interfaces 718, input devices 720, and storage devices 722. Network interfaces may include for example an Ethernet or WiFi adapter. Input devices 720 may be any known input device technology, including but not limited to a keyboard (including a virtual keyboard), mouse, track ball, and touch-sensitive pad or display. Storage devices 722 may include one or more mass storage devices for storing data files; such devices include magnetic disks, such as internal hard disks and removable disks; magneto-optical disks; and optical disks.

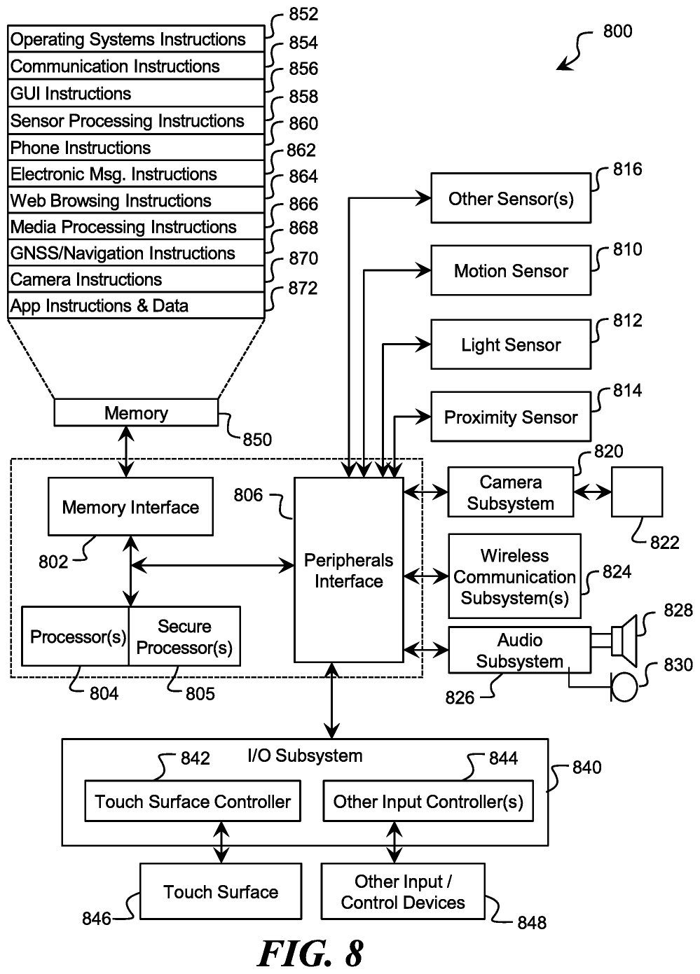

FIG. 8 shows a user device 800, according to an embodiment of the present disclosure. The illustrative user device 800 may include a memory interface 802, one or more data processors, image processors, central processing units 804, and/or secure processing units 805, and a peripherals interface 806. The memory interface 802, the one or more processors 804 and/or secure processors 805, and/or the peripherals interface 806 may be separate components or may be integrated in one or more integrated circuits. The various components in the user device 800 may be coupled by one or more communication buses or signal lines.

Sensors, devices, and subsystems may be coupled to the peripherals interface 806 to facilitate multiple functionalities. For example, a motion sensor 810, a light sensor 812, and a proximity sensor 814 may be coupled to the peripherals interface 806 to facilitate orientation, lighting, and proximity functions. Other sensors 816 may also be connected to the peripherals interface 806, such as a global navigation satellite system (GNSS) (e.g., GPS receiver), a temperature sensor, a biometric sensor, magnetometer, or other sensing device, to facilitate related functionalities.

A camera subsystem 820 and an optical sensor 822, e.g., a charged coupled device (CCD) or a complementary metal-oxide semiconductor (CMOS) optical sensor, may be utilized to facilitate camera functions, such as recording photographs and video clips.

Communication functions may be facilitated through one or more wired and/or wireless communication subsystems 824, which can include radio frequency receivers and transmitters and/or optical (e.g., infrared) receivers and transmitters. For example, the Bluetooth (e.g., Bluetooth low energy (BTLE)) and/or WiFi communications described herein may be handled by wireless communication subsystems 824. The specific design and implementation of the communication subsystems 824 may depend on the communication network(s) over which the user device 800 is intended to operate. For example, the user device 800 may include communication subsystems 824 designed to operate over a GSM network, a GPRS network, an EDGE network, a WiFi or WiMax network, and a Bluetooth™ network. For example, the wireless communication subsystems 824 may include hosting protocols such that the device 800 can be configured as a base station for other wireless devices and/or to provide a WiFi service.

An audio subsystem 826 may be coupled to a speaker 828 and a microphone 830 to facilitate voice-enabled functions, such as speaker recognition, voice replication, digital recording, and telephony functions. The audio subsystem 826 may be configured to facilitate processing voice commands, voiceprinting, and voice authentication, for example.

The I/O subsystem 840 may include a touch-surface controller 842 and/or other input controller(s) 844. The touch-surface controller 842 may be coupled to a touch surface 846. The touch surface 846 and touch-surface controller 842 may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 846.

The other input controller(s) 844 may be coupled to other input/control devices 848, such as one or more buttons, rocker switches, thumb-wheel, infrared port, USB port, and/or a pointer device such as a stylus. The one or more buttons (not shown) may include an up/down button for volume control of the speaker 828 and/or the microphone 830.

In some implementations, a pressing of the button for a first duration may disengage a lock of the touch surface 846; and a pressing of the button for a second duration that is longer than the first duration may turn power to the user device 800 on or off. Pressing the button for a third duration may activate a voice control, or voice command, module that enables the user to speak commands into the microphone 830 to cause the device to execute the spoken command. The user may customize a functionality of one or more of the buttons. The touch surface 846 can, for example, also be used to implement virtual or soft buttons and/or a keyboard.

In some implementations, the user device 800 may present recorded audio and/or video files, such as MP3, AAC, and MPEG files. In some implementations, the user device 800 may include the functionality of an MP3 player, such as an iPod™. The user device 800 may, therefore, include a 36-pin connector and/or 8-pin connector that is compatible with the iPod. Other input/output and control devices may also be used.

The memory interface 802 may be coupled to memory 850. The memory 850 may include high-speed random access memory and/or non-volatile memory, such as one or more magnetic disk storage devices, one or more optical storage devices, and/or flash memory (e.g., NAND, NOR). The memory 850 may store an operating system 852, such as Darwin, RTXC, LINUX, UNIX, OS X, WINDOWS, or an embedded operating system such as VxWorks.

The operating system 852 may include instructions for handling basic system services and for performing hardware dependent tasks. In some implementations, the operating system 852 may be a kernel (e.g., UNIX kernel). In some implementations, the operating system 852 may include instructions for performing voice authentication.

The memory 850 may also store communication instructions 854 to facilitate communicating with one or more additional devices, one or more computers and/or one or more servers. The memory 850 may include graphical user interface instructions 856 to facilitate graphic user interface processing; sensor processing instructions 858 to facilitate sensor-related processing and functions; phone instructions 860 to facilitate phone-related processes and functions; electronic messaging instructions 862 to facilitate electronic-messaging related processes and functions; web browsing instructions 864 to facilitate web browsing-related processes and functions; media processing instructions 866 to facilitate media processing-related processes and functions; GNSS/Navigation instructions 868 to facilitate GNSS and navigation-related processes and instructions; and/or camera instructions 870 to facilitate camera-related processes and functions.

The memory 850 may store app instructions and data 872 to perform some of the processing described above in conjunction with FIGS. 3-6.

Each of the above identified instructions and applications may correspond to a set of instructions for performing one or more functions described herein. These instructions need not be implemented as separate software programs, procedures, or modules. The memory 850 may include additional instructions or fewer instructions. Furthermore, various functions of the user device 800 may be implemented in hardware and/or in software, including in one or more signal processing and/or application specific integrated circuits.

In some embodiments, processor 804 may perform processing including executing instructions stored in memory 850, and secure processor 805 may perform some processing in a secure environment that may be inaccessible to other components of user device 800. For example, secure processor 805 may include cryptographic algorithms on board, hardware encryption, and physical tamper proofing. Secure processor 805 may be manufactured in secure facilities. Secure processor 805 may encrypt data/challenges from external devices. Secure processor 805 may encrypt entire data packages that may be sent from user device 800 to the network. Secure processor 805 may separate a valid user/external device from a spoofed one, since a hacked or spoofed device may not have the private keys necessary to encrypt/decrypt, hash, or digitally sign data, as described herein.

Methods described herein may represent processing that occurs within a system . . . (e.g., system 100 of FIG. 1). The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, such as EPROM, EEPROM, flash memory device, or magnetic disks. The processor and the memory can be supplemented by, or incorporated in, special purpose logic circuitry.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A method for improved reliability of a bank computer network, the method comprising:
monitoring resources for a plurality of stationary banking locations, wherein the resources comprise at least one of cash reserves, power, and network connectivity;
detecting a first one of the plurality of stationary banking locations is deficient in one or more of its monitored resources by:
analyzing historical customer activity data associated with the first of the plurality of stationary banking locations;
monitoring real-time customer activity; and
based on the analyzing and monitoring, predicting an expected demand in services associated with the first one of the plurality of stationary banking locations, the expected demand exceeding the one or more monitored resources associated with the first one of the plurality of stationary banking locations;
determining a first target location for a first mobile banking unit (MBU) based on the location of the first one of the plurality of stationary banking locations;
deploying the first MBU to the first target location; and
sending a notification to a plurality of user devices, the notification comprising a location of the first MBU and information about services provided by the first MBU.

2. The method of claim 1 wherein monitoring resources for a plurality of banking locations comprises using a weather forecast to estimate resources for the plurality of banking locations at a future time.

3. The method of claim 1 wherein monitoring resources for a plurality of banking locations comprises receiving resource data from a utility provider.

4. The method of claim 1 wherein determining the target location comprises: estimating customer demand for banking services within a geographic area.

5. The method of claim 1 wherein deploying the first MBU to the first target location comprises deploying the first MBU using a self-driving vehicle.

6. The method of claim 1 wherein sending the notification to the plurality of user devices comprises transmitting the notification to the plurality of user devices using peer-to-peer communications.

7. A method comprising:
determining a target location for a mobile automatic teller machine (ATM) by:
monitoring resources for a plurality of banking locations;
detecting a first one of the plurality of banking locations is deficient in one or more of its monitored resources by:
analyzing historical customer activity data associated with the first of the plurality of stationary banking locations;
monitoring real-time customer activity; and
based on the analyzing and monitoring, predicting an expected demand in services associated with the first one of the plurality of stationary banking locations, the expected demand exceeding the one or more monitored resources associated with the first one of the plurality of stationary banking locations; and
determining the target location based on a location of the first one of the plurality of banking locations;
deploying the mobile ATM to the target location; and
transmitting the target location from the mobile ATM to a plurality of user devices using peer-to-peer communications, each of the plurality of user devices configured to present a user interface (UI) showing the target location of the mobile ATM on a map.

8. (canceled)

9. The method of claim 7 wherein the one or more resources comprise at least one of:
cash;
power; and
network connectivity.

10. The method of claim 7 wherein determining the target location comprises: estimating customer demand for banking services within a geographic area.

11. The method of claim 7 wherein at least one of the plurality of user devices is configured to switch from server mode to peer mode based on network connectivity.

12. The method of claim 7 wherein deploying the mobile ATM to the target location comprises deploying the mobile ATM using a self-driving vehicle.

13. The method of claim 7 comprising:
determining a first location of the mobile ATM;
transmitting the first location of the mobile ATM to the plurality of user devices;
determining a second location of the mobile ATM;
transmitting the second location of the mobile ATM to the plurality of user devices,
wherein each of the plurality user devices is configured to present the UI showing a tracked location of the mobile ATM, the tracked location based on at least the first location and the second location.

14. A system comprising:
a processor;
a resource monitoring module configured for execution on the processor to:
monitor resources for a plurality of banking locations, and
detect a first one of the plurality of banking locations is deficient in one or more of its monitored resources by:
analyzing historical customer activity data associated with the first of the plurality of stationary banking locations;
monitoring real-time customer activity; and
based on the analyzing and monitoring, predicting an expected demand in services associated with the first one of the plurality of stationary banking locations, the expected demand exceeding the one or more monitored resources associated with the first one of the plurality of stationary banking locations;
a mobile banking unit (MBU) deployment module configured for execution on the processor to:
determine a first target location for a first MBU based on the location of the first one of the plurality of banking locations, and
deploy the first MBU to the first target location; and
a customer notification module configured for execution on the processor to:
send a notification to a plurality of user devices, the notification comprising a location of the first MBU and information about services provided by the first MBU.
